(19) United States
(12) Patent Application Publication
(10) Pub. No.: US 2005/0072801 A1
(43) Pub. Date: Apr. 7, 2005

(54) Multi-compartmented propel container

(75) Inventors: Robert W. Chadfield, Chaska, MN (US); Frank J. Lang, Plainfield, IL (US)

Correspondence Address: BREINER & BREINER, 115 NORTH HENRY STREET, P. O. BOX 19290, ALEXANDRIA, VA, 22314, US

(73) Assignee: Federal Package Network, Inc., Chaska, MN (US)

(21) Appl. No.: 10/663,735

(22) Filed: Sep. 17, 2003

(51) Int. Cl. B67D 5/60

(52) U.S. Cl. 222/145.1

(57) ABSTRACT

A multi-compartmented propel container is provided for a viscous product, such as gels, creams, etc. that maintain separate certain components of the product during storage and allows combination of the components just prior to use. The container includes multiple compartments and a turning mechanism that propels the components of the product simultaneously from the separate compartments into a dispensing outlet where the components come together in admixture and are then ready for application by a user. The turning mechanism also can be structured to allow for repel of the product components, if desired.

### FIELD OF INVENTION

The invention is directed to propel dispensing containers. Specifically, the containers of the invention are multi-compartmented propel containers for viscous products, such as gels, creams, or soft solid-type products, in particular having components which are preferably maintained separate during storage but are preferably or required to be combined prior to use. The propel containers can be propel only or propel/repel as to the product. Further, the containers can be structured for product discharge through the top or the base of the container with the propel mechanism being at the opposite end.

### BACKGROUND OF THE INVENTION

Propel containers conventionally have a single chamber. Such containers have been used for products in the form of a “stick”, for example, for products applied to human skin in use, such as lip balms, deodorants, and make-up compositions, or for products suitable for glide application, e.g., glue. Some compositions, such as medicated compositions, require separation of certain active ingredients prior to the application to a surface to be treated so as to maintain effectiveness of the composition over a period of storage. This requires two separate compositions in two separate containers. Use requires mixing at the point of application or on a third surface prior to application. Disadvantages of this arrangement are loss of one container making the other container useless, uneven dispensing from the two containers resulting in running out of one component prior to the other or ineffective application, uneven mixing when applied separately at the point of application resulting in decreased effectiveness of the product, or mixing on a separate surface resulting in inconvenience and added clean up.

Accordingly, there is a need for a container wherein two or more components of a product are maintained separate in storage while allowing mixing and dispensing just prior to use so as to avoid the above-described disadvantages.

### OBJECTS AND BRIEF DESCRIPTION OF THE INVENTION

Accordingly, it is a primary object of the invention to provide a container that separately stores two or more components of a product and provides for combination of these components just prior to use.

It is a further object of the invention to provide a common actuator for simultaneously dispensing the contents of the multiple compartments.

It is a further object of the invention to provide a multi-compartmented container that maintains two or more components of a viscous product separate in storage and provides means for simultaneously dispensing the components from the separate compartments into a common mixing and dispensing chamber just prior to use.

A further object of the invention is to provide a multi-compartmented container that maintains two or more components of a viscous product separate in storage and provides a spout means for simultaneously dispensing the components from the separate compartments just prior to use, in particular wherein the spout means can be present at a top end of the container or in a bottom end of the container.

The container of the invention includes a housing and at least two compartments, preferably cylindrical, within the housing. Each compartment includes a support base, e.g., a follower plate or elevator, threadedly connected to an axially rotatable shaft. A rotatable control mechanism is attached to the base of each shaft. The control mechanisms are wheel-like structures with spaced apart protrusions or teeth. Each separate control mechanism in turn is interrelated to a common or primary rotatable control mechanism. The primary control mechanism is a rotatable wheel-like structure having an upwardly extending projection with spaced protrusions or teeth positioned between and which interacts as a drive gear with the teeth of each control mechanism (secondary control mechanism) connected to each compartment shaft. A viscous component or composition containing the component of the product is maintained in each compartment during use of the container, initially filling the compartment and being supported on the support base. When the primary control mechanism is turned by a user, the teeth of the drive gear thereof interacts with the teeth of the secondary control mechanisms to simultaneously turn the secondary control mechanisms resulting in a propelling upward of the support base on the threaded shaft and thus upward movement of each component or composition present in the separate compartments.

At the top of each compartment is at least one opening into a common mixing and/or dispensing chamber. The dispensing chamber may allow for mixing prior to application, e.g. the components or compositions of the separate compartments are propelled so that an amount from each compartment enters the chamber where the components or compositions are brought into admixture. The mixing chamber opens outward of the exterior surface of the housing so that the chamber is accessible to a user. Thus, the admixture is accessible and ready for application by a user, such as by a user's finger, a swab or the like. Alternatively, the common dispensing chamber may have the form of a spout with side-by-side passages and dispensing orifices. The components or compositions are thus dispensed simultaneously to the same spot. The portion of the housing providing the mixing and/or dispensing chamber can be an integral part of the housing or, preferably, is an insert to the housing allowing for ready structural variation during manufacture.

The housing of the container is constructed and arranged to encompass the separate compartments and the primary and secondary control mechanisms in such a manner as to provide one unitary package. The container of the invention maintains separate component storage compartments together in one structure and allows for simultaneous dispensing of components therefrom into a common mixing and/or dispensing chamber. Accordingly, the disadvantages of the prior art are avoided.

The housing generally has the dispensing end at the top of the housing and the drive gear in the base of the housing. In an alternative embodiment, especially suitable for use with a dispensing spout, the dispensing end is in the base of the housing and the drive gear at the top of the housing. A base cover can be provided to allow the housing to be free-standing when not in use. With a gel or viscous liquid, gravity thereby maintains the product in the dispensing end of the housing in a sealed manner until ready for dispensing. The spout is thereby positioned in a direction ready for use making dispensing and application easier for the user.

The propel container can be structured to also allow repel of the product support base. Thus, the material can be moved away from the discharge opening when not in use.

The container may include in the exterior front and/or back walls thereof a recessed area to provide a hand grip for the user.

The above and other features of the invention will become more apparent from the following detailed description, in particular when taken in conjunction with the accompanying figures.

### BRIEF DESCRIPTION OF DRAWINGS

FIG. 1 is a cross-sectional front view of a preferred embodiment of a housing for the container of the invention.

FIG. 2 is a top view of the housing shown in FIG. 1.

FIG. 3 is a bottom view of the housing shown in FIG. 1.

FIG. 4 is a cross-sectional front view of a first embodiment of the container of the invention.

FIG. 5 is a cross-sectional side view of a mixing and dispensing chamber insert as present in the container shown in FIG. 4.

FIG. 6 is a top view of the insert as shown in FIG. 5.

FIG. 7 is a bottom view of the insert as shown in FIG. 5.

FIG. 8 is a cross-sectional side view of the drive gear as present in the container of the invention.

FIG. 9 is a top view of the drive gear of FIG. 8.

FIG. 10 is a bottom view of the drive gear of FIG. 8.

FIG. 11 is a dispensing chamber including a spout suitable for insertion in the housing shown in FIG. 1.

FIG. 12 is a bottom view of the insert shown in FIG. 11.

FIG. 13 is an alternative embodiment of the container of the invention including a spout insert for bottom dispensing with a base cover.

FIG. 14 is a cross-sectional view of the base cover shown in FIG. 13.

FIG. 15 is a top view of the container shown in FIG. 13.

FIG. 16 is a partial cross-sectional view of a further embodiment of the container of the invention wherein discharge of a product occurs through the base.

FIG. 17 shows a front exterior view of the container of FIG. 16, wherein the exterior front wall includes a recessed area.

FIG. 18 is a perspective view including a back exterior view of the container of FIG. 16.

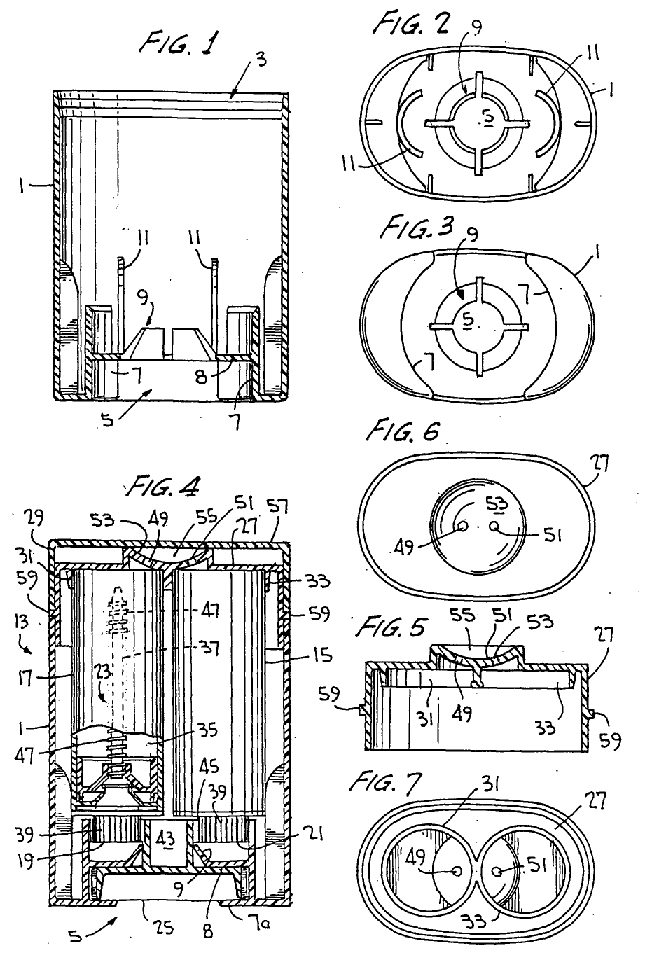

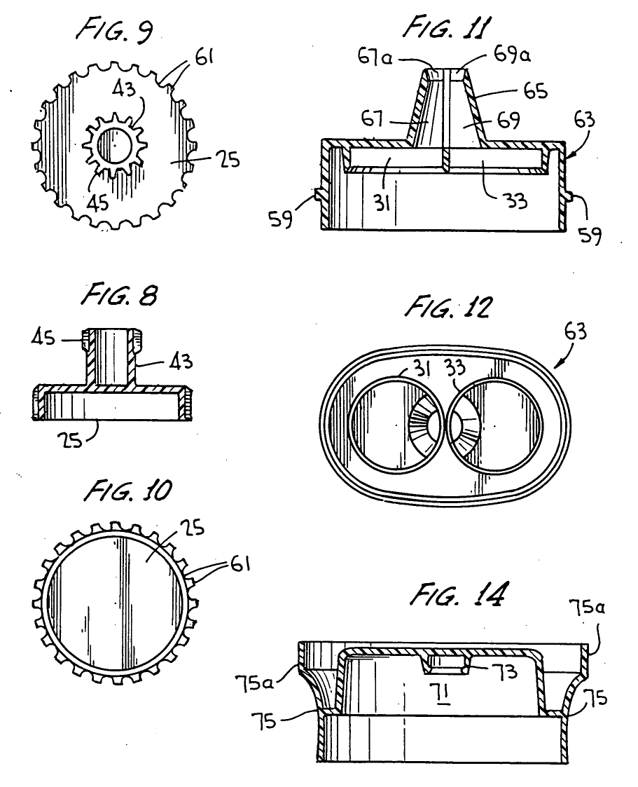

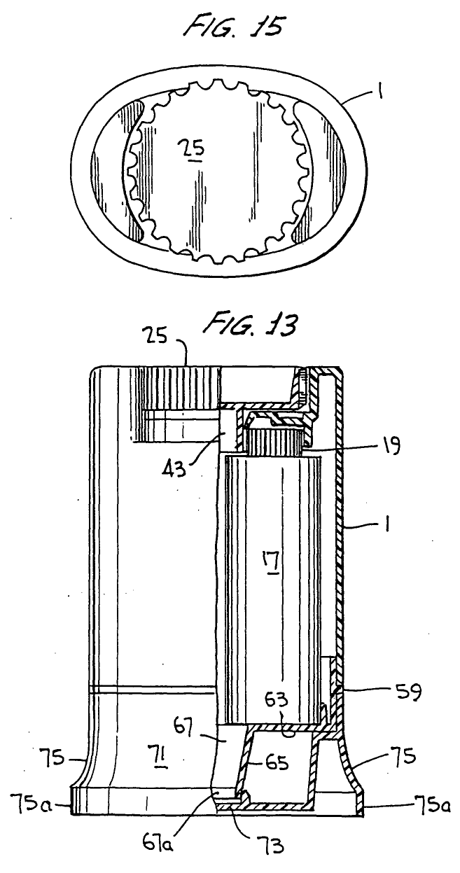

### DETAILED DESCRIPTION OF THE INVENTION

The container of the invention is preferably of multiple parts which allow for easy manufacture of the container, product filling of the container and assembly to provide the finished container. This also allows for interchangeability between certain parts to provide for versatility in structure and thus use. Certain features of the container, however, as described below as separate can if desired be made integral with other parts and still encompass the novel features of the invention.

The container of the invention includes a housing 1 as shown in FIG. 1. The housing 1 preferably has an open top 3 and a partial open bottom 5. The housing includes interior walls 7 which extend upward to a cross-secting wall 8 to a conical wall portion 9. Curved projections 11 extend upward from the cross-secting wall 8.

Housing 1 is constructed to receive and retain certain insertable parts to provide the container 13 such as shown in a first embodiment in FIG. 4 or alternative embodiments as shown in FIGS. 13 and 16. With respect to the embodiment of FIG. 4, the insertable parts include first and second compartments 15 and 17, rotatable control mechanism 19 and 21 connected to a propel or propel/repel mechanism 23 as shown in compartment 17, a drive gear 25 connecting control mechanisms 19 and 21, a dispensing chamber insert 27 which is in fluid connection with compartments 15 and 17, and a closure 29. Compartments 15 and 17 are preferably cylindrical. Compartments 15 and 17 are held in position within housing 1 by downward projections 31 and 33 of insert 27. Projections 31 and 33 are preferably in the form of a continuous wall or ring which receives in a sealing manner the top or dispensing end of compartments 15 and 17. The projections 31 and 33 may alternatively be discontinuous, i.e., a plurality of spaced apart projections which hold the compartments sealingly to the underside of insert 27. The bottom of compartments 15 and 17 are held at their bottom portions as further described below.

Each compartment is structured as a propel or a propel/repel container. For ease of discussion the invention will be described in terms of a propel mechanism. Within each compartment (but only shown with respect to compartment 17) is a support base 35 (e.g., a follower plate or elevator) which is threadedly connected to a vertically extending shaft 37. Each shaft 37 is in turn connected to a rotatable control mechanism 19 and 21 respectively. Mechanism 19 has a plurality of protrusions or teeth 39. A primary rotatable control mechanism 25 is provided in addition to control mechanisms 19 and 21 (the secondary control mechanisms). Control mechanism 25 includes an upward projection 43 which serves as a drive gear for secondary control mechanisms 19 and 21. Drive gear 43 contains protrusions or teeth 45 which intermesh with teeth 39.

Secondary control mechanisms 19 and 21 are axially connected to the shaft 37 of the propel mechanism. When separate components or compositions are present as contents in compartments 15 and 17, such is supported on support base 35. Dispensing is performed by a user by rotating the primary control mechanism 25 which in turn through drive gear 43 rotates secondary control mechanisms 19 and 21 which axially rotate connected shafts 37 causing support bases 35 to propel upward along the screw threads 47 of shaft 37. This action causes a propelling outward of the contents of each compartment through openings 49 and 51 present in the top wall 53 of chamber insert 27 in housing 1. Insert 27 closes the tops of compartments 15 and 17.

Openings 49 and 51 lead into a mixing chamber 55 wherein the components or compositions previously maintained separate in compartments 15 and 17 are simultaneously dispensed for admixture in a common chamber. The chamber can be an exterior container surface, which is preferably indented inward, more preferably as a downwardly curved surface, to provide for better containment and control over the product. A user can then take up the admixture from the mixing chamber for application in use by a finger, swab or the like. A curved surface allows for easy movement across the surface and clean uptake of the product thereon. A cover 57 can be provided to close off mixing chamber 55 when not in use. The cover can be a snap-fit or friction fit or screw-on type cap seated on shoulders 59. The cover may optionally include downward projections to provide for a secondary closure around mixing chamber 55.

The secondary control mechanisms 19 and 21 are preferably closed off by the housing 1 from access to a user. The primary control mechanism 25 is preferably partially closed off by an extension 7a to wall 7. Primary control mechanism by drive gear 43 preferably snap-fits into conical wall portion 9. The housing 1 preferably closes off all but two side portions of primary control mechanism 25. The side portions, preferably scalloped 61 for better control thereof, are sized to allow a user to turn control mechanism 25 to provide dispensing of a product as described above.

The container can be structured with a propel/repel mechanism to allow reverse turning of control mechanism 25, secondary control mechanisms 19 and 21 to cause shafts 37 to reverse in rotation and thus to repel support bases 35 back down into compartments 15 and 17.

An alternative embodiment is essentially the same as shown in FIG. 4 except rather than using dispensing insert 27, dispensing insert 63 as shown in FIGS. 11 and 12 can be utilized. Insert 63 includes a spout portion 65. By providing the desired dispensing structure in an insert for housing 1, greater versatility in the structure and manufacture of the container of the invention is provided. Necessarily, the dispensing structure could be made as an integral part of housing 1 as a top surface if desired.

Dispensing insert 63 is inserted into open top 3 of housing 1 so that shoulders 59 rest on the upper wall of the open top 3 of housing 1. Downward projecting wall portions 31 and 33 receive and sealingly hold the tops of compartments 15 and 17 to insert 63. To provide for dispensing of product from compartments 15 and 17, insert 63 includes spout portion 65 having dispensing passages 67 and 69 which separately connect to compartments 17 and 15 respectively. As a component or composition contained in compartments 15 and 17 are propelled upward, the components and compositions propel into passages 67 and 69 and ultimately through openings 67a and 69a at which point the dispensed materials become commingled for application directly to a surface to be treated or to an intermediate applicator, e.g. a finger, swab, pad, or the like.

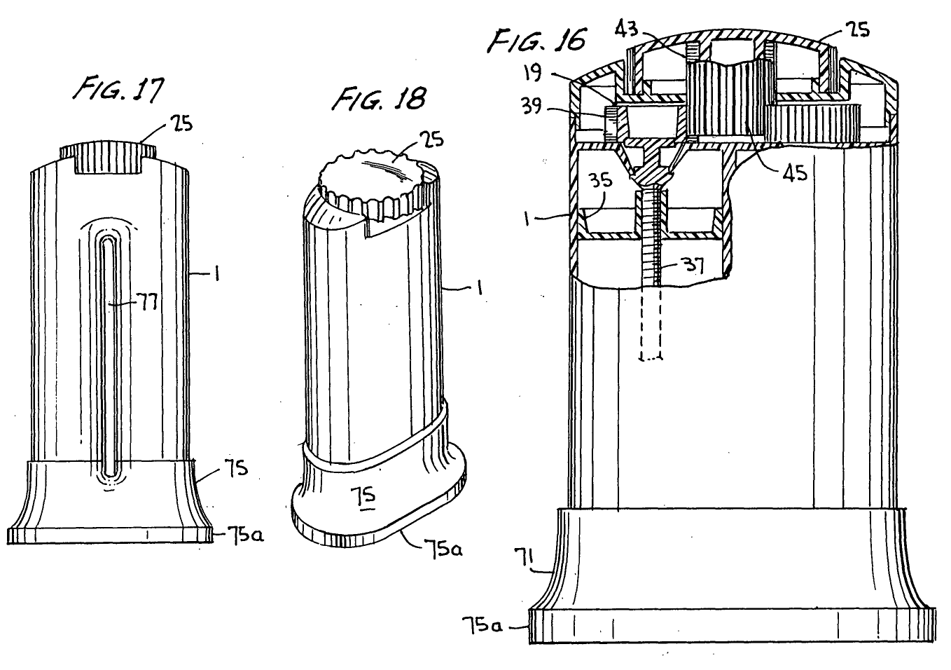

A further embodiment of the container of the invention including the spout-containing insert 63 is shown in FIGS. 13-15 and 16-18. The container as illustrated in FIGS. 13 and 16 includes a housing 1 with compartments 15 and 17, secondary control mechanisms 19 and 21, primary control mechanism 25, dispensing insert 63 including spout 65 as shown in the embodiment of FIG. 4 with the exception that the primary control mechanism 25 is present at the top of the container and the spout 65 for dispensing is present in the bottom of the container. In the embodiment of FIG. 13, the control mechanism at the top is flush with the top of the container. In FIG. 16 the control mechanism extends above the top of the container and is more prominent. A closure 71 is provided for sealing passage openings 67a and 69a and to provide a support base so that the container may stand upright with the spout positioned downward. Closure 71 includes an upward projecting wall 73 for sealing openings 67a and 69a of spout 65. Closure 71 additionally includes side walls 75 which flare outward to provide a bottom portion 75a of greater width which serves as a base upon which the container stands during non-use. Such container structure allows for the container to be positioned in a direction for dispensing and application.

The container may include a recessed area in one or both of the exterior front and/or back walls of the container. FIG. 17 illustrates a recessed area 77 present in the front wall of the container which can serve as a hand grip for a user. The recessed area can be provided in various shapes and dimensions.

In assembly, compartments 15 and 17 with secondary control mechanisms 19 and 21 are separately assembled and, thereafter, placed in housing 1. Primary control mechanism 25 is snap-fit into conical wall portion 9. Preferably compartments 15 and 17 are filled with a desired product component or composition prior to placement in housing 1. Once compartments 15 and 17 are filled and placed in housing 1, dispensing insert 27 or 63 is positioned in open top 3 thereof.

A container according to the invention can be used for storing and dispensing various products. Most advantageously, however, the container of the invention is useful for medicated viscous products, such as gels and creams to be applied to skin for treatment of various dermatological conditions, such as acne. The size of the container, and consequently the sizes of its parts, can vary depending on the product contained within it.

Parts of the container of the present invention are preferably molded from plastic materials. As set forth above, various parts of the container can be molded separately or as integral units.

Variations to the preferred embodiments of the invention are also envisioned depending on the product that the container is to hold and dispense. For example, a container may include more than two compartments when the product has more than two components which should be maintained separate. In this alternative embodiment, a control mechanism for each additional compartment will be provided and the size of the drive gear accordingly adjusted. Alternatively, the separate compartments may have different sizes or the speed of propelling a support base along a shaft may vary (e.g., by varying the spacing of the screw threads) in each separate compartment. The separate compartments may be integrally formed with a common center wall rather than separately as shown in FIG. 4.

As will be apparent to one skilled in the art, various modifications can be made within the scope of the aforesaid description. Such modifications being within the ability of one skilled in the art form a part of the present invention and are embraced by the appended claims.

1. A container comprising:
a housing;
a dispensing outlet outwardly accessible from an exterior surface of said housing;
at least two compartments within said housing;
at least one opening connecting each component of said at least two compartments with said dispensing outlet chamber;
a threaded shaft within each of said at least two compartments;
support means threadedly connected to each said shaft and structured to support contents within each of said at least two compartments;
a first and a second rotatable control mechanism wherein one of said first and said second control mechanism is operably connected to each said shaft; and
a third rotatable control mechanism with a drive gear, wherein said drive gear is operatively positioned in relation to said first and said second rotatable control mechanism.

2. A container according to claim 1, wherein said dispensing outlet includes a mixing chamber which is in communication with said at least one opening connecting each said compartment of said at least two compartments.

3. A container according to claim 2, wherein said mixing chamber is an open top inwardly curved chamber.

4. A container according to claim 1, wherein said dispensing outlet comprises an outward extending spout with separated passages therein which are each in communication respectively with said at least one compartment of said at least two compartments.

5. A container according to claim 4, wherein said spout is present in a bottom wall of said housing.

6. A container according to claim 5, further comprising a closure for said spout having a base surface for supporting said container in an upright position.

7. A container according to claim 1, wherein said dispensing outlet is present in an insert seated in an opening in said housing.

8. A container according to claim 1, wherein said at least two compartments are cylindrical.

9. A container according to claim 1, wherein said housing includes a bottom portion enclosing said first and said second rotatable control mechanism and partially enclosing said third rotatable control mechanism.

10. A container according to claim 1, wherein said first and said second rotatable control mechanism are constructed and arranged to allow propelling and repelling of said support means along said threaded shaft.

11. A container according to claim 1, wherein said first and said second rotatable control mechanism are constructed and arranged to allow propelling only of said support means along said threaded shaft.

12. A container according to claim 1, wherein said at least two compartments have different volume capacities.

13. A container according to claim 1, wherein threading on each said shaft is differently spaced.

14. A container according to claim 1, wherein said housing includes an interior conical wall for receiving said drive gear of said third rotatable control mechanism.

15. A container according to claim 1, wherein at least one exterior wall of said housing has a recessed area providing a hand grip.
